(19) United States
(12) Patent Application Publication
(10) Pub. No.: US 2019/0186530 A1
(43) Pub. Date: Jun. 20, 2019

(54) REINFORCED PIVOT PIN RECEPTACLE

(71) Applicant: I.G. CARDBOARD TECHNOLOGIES LTD., Tel Aviv (IL)

(72) Inventor: Izhar GAFNI, Ahituv (IL)

(21) Appl. No.: 16/327,976

(22) PCT Filed: Aug. 24, 2017
(86) PCT No.: PCT/IL2017/050943

§ 371 Date: Feb. 25, 2019

(30) Foreign Application Priority Data
Aug. 24, 2016 (IL) 247456

(51) Int. Cl. F16C 11/04

(52) U.S. Cl. CPC F16C 11/04; B62K 21/02

(57) ABSTRACT

The present disclosure relates to a reinforced pivot pin receptacle, specifically made of plastic or other non-metal material and a method for adhering planar element to a cardboard surface, specifically wherein the planar element is made of plastic.

### TECHNOLOGICAL FIELD

The present disclosure relates to a reinforced pivot pin receptacle, specifically made of plastic or other non-metal material and a method for adhering planar element to a cardboard surface, specifically wherein the planar element is made of plastic.

### BACKGROUND ART

References considered to be relevant as background to the presently disclosed subject matter are listed below:

WO 2011/067742

WO 2016/071895

WO 2014/178038

WO 2015/104701

Acknowledgement of the above references herein is not to be inferred as meaning that these are in any way relevant to the patentability of the presently disclosed subject matter.

### BACKGROUND

Non-metal pivots or axles are extensively used in a variety products and for various purposes. A main reason for this extensive use is the low cost of such materials and the ease of their manufacturing compared to similar pivots made of metal or complex materials. One of the disadvantage associated with using non-metal materials, such as plastic, as pivots or pivot pin receptacles is a relatively low load bearing, especially for dynamic loads. The pivot receptacle is typically the weakest part of a two-membered assembly in which the members are pivoted to one another, and in many instances may be the failure point of the assembly. Thus, there is a need for pivots and pivot receptacles made of non-metal materials having increased load bearing capacity.

Another point of mechanical failure in such assemblies may originate from the insufficient strength of the adhesion interface between different elements of the assembly. This is particularly the case when the pivot pin receptacle is made of a different material (e.g. plastic) than the structural element to which is it affixed (e.g. cardboard structural elements). Thus, there is also a need for devices and methods that provide strong and robust attachment of elements made of different materials.

### GENERAL DESCRIPTION

One aspect of the present disclosure provides a device, which may be used as a pivot pin receptacle for a cardboard unit. For ease of reference, this aspect will be referred to herein as “the Device Aspect”.

The device of the Device Aspect comprises a hollow member with an elongated bore that defines a longitudinal axis. Typically, the hollow member has a generally tubular shape. Although the hollow member may be in the form of an elongated tube (i.e. the longitudinal axis being defined by the tube's bore) with a cross-section perpendicular to the longitudinal axis being circular, hollow members having differently shaped cross-sections may also be used, such as triangle, rectangular, trapezoid, hexagonal, oval, etc. In addition, the hollow member may be constituted by a circumferential wall, having a uniform or non-uniform wall thickness. The hollow member is configured for receiving therein a pivot pin.

At least one planar element extends laterally from a portion of an outer face of the hollow member, permitting the device's association with a cardboard face of a cardboard unit or between two cardboard layers of the cardboard unit. The at least one planar element thus enables fixation of the device onto or into planar structural units made of cardboard.

Typically, the planar element is integrally formed with the hollow member; however the planar element may also be attached to the hollow member by adhesive or other mechanical means.

As noted above, the planar element extends laterally from a portion of the hollow member's outer surface. The portion may be substantially equal to the length of the bore or may be smaller.

The planar element may have any desired shape, i.e. rounded, polygonal, or irregular. In some embodiment, the planar element has a generally rectangular shape, which may be defined between two edges normal to the longitudinal axis. In addition, the planar element may have a dimension extending laterally from the hollow member that is longer than the length of the portion. Namely, the length of the planar element in the lateral direction may be larger than the length of the element in the longitudinal direction (the directions of the planar element being defined in reference to the longitudinal axis of said member).

The planar element may have a uniform thickness or a variable thickness. A non-limiting example is a planar element that has a thickness which is gradually decreasing along the lateral direction of the plane. In some embodiments, the planar element has thickness less than the wall thickness of said hollow member, e.g. at least 5-folds, at times at least 10-folds or even 20-folds less than the thickness of the hollow member's wall. In some embodiments, the plane defined by the at least one planar element is parallel to the longitudinal axis. In other embodiments, the plane defined by the planar element is normal to the longitudinal axis of the hollow member. In some other embodiments, the plane of the planar element defines an angle of between 0 and 90° with respect to said longitudinal axis.

According to some embodiments, the device may comprise a plurality, i.e. at least two, planar elements. The planar elements may by parallel to one another, i.e. extending along the same lateral direction; for example, two planar elements may extend parallel to one another in a direction normal to the longitudinal axis and being distanced from one another along the hollow member's longitudinal axis. In another embodiment, each of the planar elements may extend in a different lateral direction. By further embodiments, the planar elements may be equally or non-equally distanced from one another along the circumference of the hollow member. In a particular embodiment, the device (i.e. the pivot pin receptacle) comprises one or more pairs of oppositely extending planar elements.

It is further contemplated that the planar elements be different from one another by at least one of size, shape and thickness.

In some embodiments the pivot pin receptacle is made of a polymeric material (i.e. plastic). The polymeric material may comprise a single polymer, a co-polymer, a terpolymer, or a blend of polymers. In some other embodiments, the device may be made of a composite material, for example a fibrous matrix impregnated with a polymer. In another embodiment, the device may be made of a woven fibrous material.

The pivot pin receptacle may, by some embodiments, be used for pivotally coupling two members of a cardboard bicycle's steering mechanism, e.g. for inclusion in the bicycle's fork and pivotally coupling to a front end of the bicycle's body. Such an exemplary bicycle is described in WO 2016/071895, the relevant contents of which are incorporated herein by reference.

In another aspect, the present disclosure provides an article (such as a cardboard bicycle) in which two or more members are pivotally coupled to one another by a pivot pin receptacle as described herein.

As noted above, a pivot pin receptacle of the Device Aspect described herein, and particularly (although not only) that where the planar elements are parallel to the hollow member's longitudinal axis, may be used in a bicycle's steering mechanism, wherein the steering mechanism is substantially made of cardboard, for coupling the steering fork to the bicycle's body frame; for example in a bicycle of the kind disclosed in WO 2014/178038 and WO 2016/071895. Such a use usually requires fixing the pivot pin receptacle to a cardboard surface or between two cardboard layers.

By another embodiment, a pivot pin receptacle of the Device Aspect described herein, and particularly that where the planar elements are normal to the hollow member's longitudinal axis, may be fitted in a wheel such that said hollow member is at the wheel's center, and used for coupling the wheel to a body of a wheeled device. The wheel may be made of two or more layers with the planar element being sandwiched between two layers. An example of such a wheel is a cardboard wheel of the kind disclosed in WO 2015/104701.

The fixation of the pivot pin receptacle between the cardboard layers may be by adhering the pivot pin receptacle to the cardboard. This kind of fixation is low cost and relatively easy to achieve. However, the adhesives mainly used for this kind of industrial application are either suitable for adhering plastic to plastic or cardboard to cardboard, either of which being unsuitable for adhering plastic to cardboard. This unmet need is satisfied by another aspect of the present disclosure, referred to herein as “the Fixation Aspect”.

In the Fixation Aspect, the present disclosure provides a method for fixing a planar element of a material other than cardboard to at least one cardboard surface. The method comprises (i) perforating at least one section of the planar element; (ii) applying an adhesive between the planar element and the cardboard surface such that at least a portion of the adhesive passes through the perforations; and (iii) curing the adhesive.

The planar element may be that constituting a part of the device described herein in the Device Aspect. However, the Fixation Aspect is also meant to encompass other planar elements, i.e. such that are not part of a pivot pin receptacle.

The planar element may be made of plastic, composite material or any other synthetic material.

In some embodiments the planar element is fixed between two opposite cardboard surfaces, such that the adhesive passes through the perforations and adheres the two cardboard surfaces. The adhesive may be applied on a surface of the planar element, a surface of the cardboard, or on both surfaces. The surfaces are then bringing into contact to be adhered one to the other.

In some embodiments the perforated section may constitute the majority of said planar element. In other embodiments, the planar element comprises at least two spaced-apart perforated sections. The perforations may be randomly distributed in said section; alternatively, the perforations may form a desired pattern. The perforations may have the same or different sizes and/or shapes.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1A shows an example of the device according to one embodiment of this disclosure.

FIG. 1B shows an example of the device according to another embodiment of this disclosure.

FIG. 1C shows another example of the device according to a different embodiment of this disclosure

FIG. 1D shows an example of the device according to the embodiment of FIG. 1A with a perforated planar element.

FIG. 2 shows an example of a use of the device in a steering mechanism of a bicycle.

FIG. 3 exemplifies the manner by which a planar element may be fixed to a cardboard surface.

### DETAILED DESCRIPTION OF EMBODIMENTS

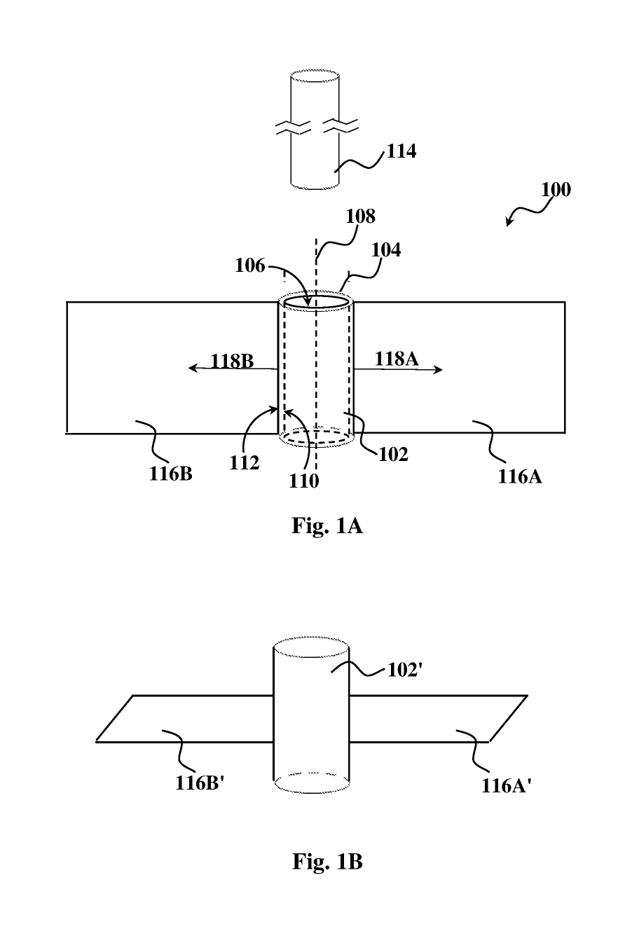

One aspect of the present disclosure is a pivot pin receptacle. FIG. 1A shows a schematic example of a device for use as a pivot pin receptacle 100, that is constituted by hollow member 102 having a tubular shape with circumferential wall 104 enclosing a longitudinal bore 106. The tubular hollow member 102 extend along a longitudinal axis 108. The circumferential wall 104 has a thickness defined between an inner circumferential face 110 and an outer circumferential face 112. The bore 106 is configured for receiving a pivot pin 114, such as a pivot pin in a steering mechanism of a bicycle.

Two planar elements 116A and 116B extend laterally from the outer circumferential face 112, such that each of the two planar elements 116A,116B lies on a plane parallel to the longitudinal axis 108, and extend to opposite lateral directions 118A,118B with respect to longitudinal axis 108. The planar elements 116A,116B typically have a thickness that is at least 5-folds smaller than the thickness of circumferential wall 104.

As noted above, other arrangements of the planar elements with respect to the tubular member are contemplated. For example, FIG. 1B is a schematic perspective view of another device according to an embodiment of this disclosure. In the embodiment of FIG. 1B the planes defined by planar elements 116A′ and 116B′ are normal to the longitudinal axis of tubular member 102′.

In another example, shown in FIG. 1C, the planar element 116C extends from the circumferential face 112 in a direction normal to the longitudinal axis 108. Planar element 116C is configured as a circumferential disk-like element that is formed with a plurality of laterally extending segments 119 (defined in the plane of the planar element 116C). In such a configuration, the planar element may be inserted between two parallel cardboard sheets in the plane defined by the cardboard sheets, with the hollow member being normal to the cardboard sheets. This may be used, for example, to articulate a cardboard wheel (e.g. of the kind described in WO 2015/104701) to a frame of a wheeled device, such that the hollow member 102 serves to accommodate the wheel's axel.

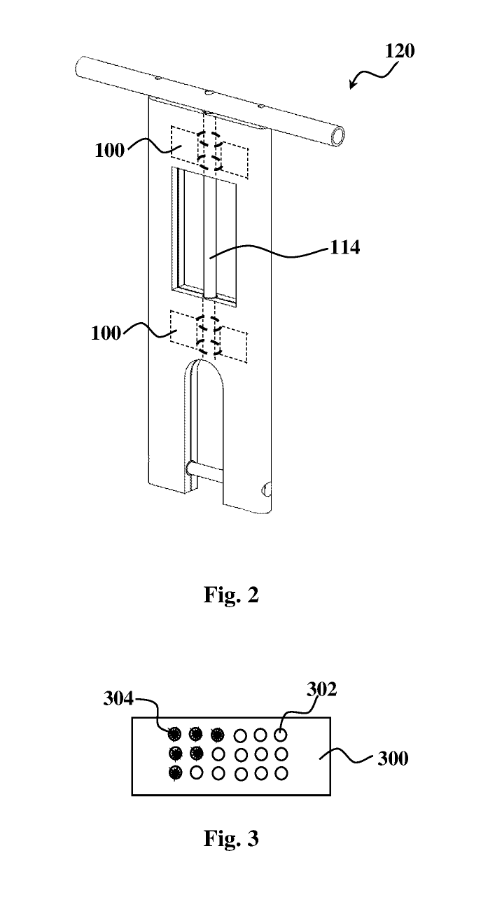

Shown in FIG. 1D are the planar elements 116A,116B formed with a plurality of perforations 120 for the purpose of fixing the device 100 to a cardboard surface with an adhesive as will be described below in connection with FIG. 3.

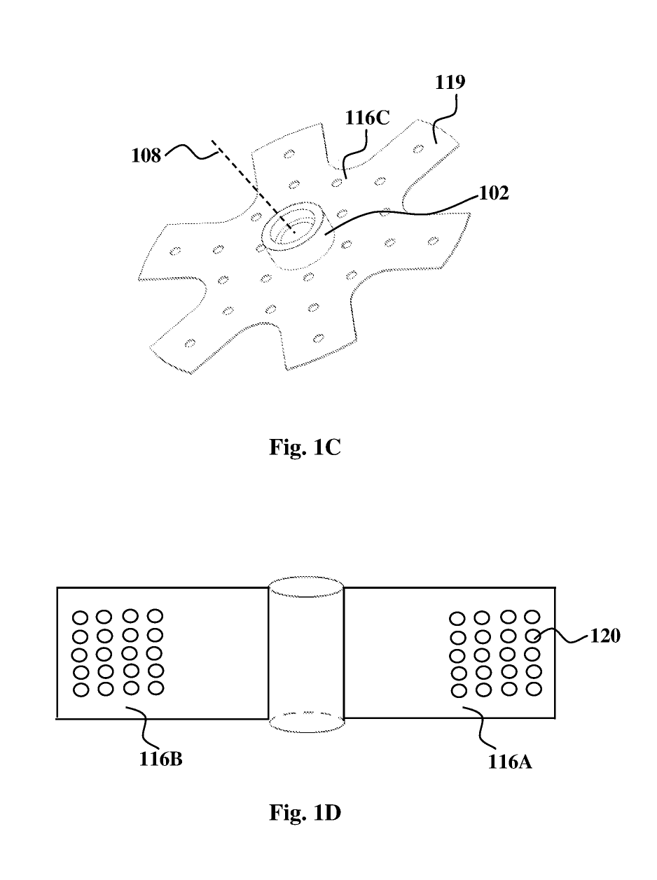

In FIG. 2 a use of the pivot pin receptacle 100 is exemplified. The pivot pin receptacle 100 is inserted into the frame of a bicycle's steering mechanism 120. In the exemplified embodiment, two pivot pin receptacles 100 are positioned in a coaxial manner at two different locations of the steering mechanism 120 to receive pivot pin 114. As can clearly be seen, the pivot pin receptacles 100 are enveloped by the material from which the frame of the steering mechanism 120 is made (for example a folded cardboard sheet) and are fixed thereto by adhering the planar elements between layers of the folded cardboard. The pivot pin 114 is inserted through the bores of the pivot pin receptacles 100. By their relatively large contacting surface areas, the planar elements stabilize the pivot pin receptacle and increase the strength of the binding between the device and the encasing cardboard frame, enabling the pivot, which may be in many cases the weakest link of such a steering mechanism, to withstand a significant higher dynamic load (i.e. increasing its fatigue resistance).

FIG. 3 schematically demonstrates the application of adhesive onto a perforated planar element according to the Fixation Aspect. In FIG. 3 a planar element 300 is provided. The planar element 300 usually made of plastic but may be made of other composite materials. The planar element 300 is perforated at a section thereof by a plurality of perforations 302. Once adhesive is applied onto the perforated section and/or on the cardboard surface to which the planar element 300 is to be attached, and the planar element is brought into contact with the cardboard surface, at least a portion of the adhesive 304 passes through at least some of the perforations 302. Subsequent to curing, the adhesive 304 forms a substantially continuous mass that holds the planar element tightly against the cardboard surface.

When the formation of a laminate is desired, or when the planar element is to be at least partially encased between two cardboard layers, the adhesive may be applied on the two opposing surfaces of the planar element and a cardboard surface may be brought into contact with each side. Adhesive may also be applied onto at least one of the cardboard surfaces. Alternatively, the adhesive may be applied only on the cardboard surfaces and the planar element may be first adhered to a first cardboard surface and then the second cardboard surface may be attached to the opposite surface of the planar element.

The cardboard may be a single cardboard sheet that is folded over the planar element to encase it. Alternatively, each layer of cardboard may be a separate sheet of cardboard.

1. A pivot pin receptacle for a cardboard unit, comprising:
a hollow member with an elongated bore defining a longitudinal axis and configured to receive a pivot; and
at least one planar element extending laterally from a portion of an outer face of the hollow member for association with a cardboard face of the unit or between two cardboard layers of the unit.

2. The pivot pin receptacle of claim 1, wherein the member is generally tubular shaped.

3. The pivot pin receptacle of claim 1, wherein the at least one planar element is integrally formed with the hollow member.

4. The pivot pin receptacle of claim 1, wherein the plane defined by the at least one planar element is parallel to the longitudinal axis.

5. The pivot pin receptacle of claim 4, wherein the portion has a length substantially equal to that of the bore.

6. The pivot pin receptacle of claim 1, wherein the at least one planar element has a dimension extending laterally longer than the length of the portion.

7. The pivot pin receptacle of claim 1, for pivotally coupling two members of a cardboard bicycle's steering mechanism.

8. The pivot pin receptacle of claim 7, for inclusion in the bicycle's fork and pivotally coupling to a front end of the bicycle's body.

9. The pivot pin receptacle of claim 1, wherein the plane defined by the at least one planar element is normal to the longitudinal axis.

10. The pivot pin receptacle of claim 9, wherein the planar element includes a plurality of radially extending portions.

11. The pivot pin receptacle of claim 9, for pivotally coupling a wheel to a body of a wheeled device.

12. The pivot pin receptacle of claim 11, wherein the wheel is made of two or more layers and the planar element is sandwiched in between two layers.

13. The pivot pin receptacle of claim 12, wherein the two layers sandwiching the planar element are made of cardboard.

14. The pivot pin receptacle of claim 1, including two or more planar elements.

15. The pivot pin receptacle of claim 14, wherein each of the two or more planar elements extends from the outer face to a different lateral direction.

16. The pivot pin receptacle of claim 15, including one or more pairs of oppositely extending planar elements.

17. The pivot pin receptacle of claim 1, wherein each of the at least one planar element has thickness less than the wall of the hollow member.

18. The pivot pin receptacle of claim 17, wherein the planar element's thickness is at least 5 folds less than the wall of the hollow member.

19. (canceled)

20. The pivot pin receptacle of claim 1, wherein the planar element is perforated.

21. The pivot pin receptacle of claim 1, for pivotally coupling two or more cardboard members.

22. (canceled)

23. (canceled)

24. (canceled)

25. (cancelled)

26. (canceled)

27. (canceled)

28. (canceled)
